(19) United States
(12) Patent Application Publication
(10) Pub. No.: US 2017/0053559 A1
(43) Pub. Date: Feb. 23, 2017

(54) HAPTIC HANDRAIL COVER AND VEHICLE HAVING THE COVER

(71) Applicant: SIEMENS AKTIENGESELLSCHAFT, Muenchen (DE)

(72) Inventors: FRITZ LEIKER, ERLANGEN (DE); TINA EUFINGER, ERLANGEN (DE); KONSTANTIN RUBINCHIK, NUERNBERG (DE)

(21) Appl. No.: 15/241,306

(22) Filed: Aug. 19, 2016

(30) Foreign Application Priority Data
Aug. 19, 2015 (DE) 102015215780.6

(51) Int. Cl. G09B 21/00; B60R 13/02

(52) U.S. Cl. CPC G09B 21/003; B60R 13/02

(57) ABSTRACT

A cover for a handrail of a public transportation vehicle is constructed to be releasably connected to the handrail. The cover includes characters in blind script for conveying information to visually impaired passengers. A public transportation vehicle having at least one cover is also provided.

### CROSS-REFERENCE TO RELATED APPLICATION

This application claims the priority, under 35 U.S.C. §119, of German Patent Application DE 10 2015 215 780.6, filed Aug. 19, 2015; the prior application is herewith incorporated by reference in its entirety.

### BACKGROUND OF THE INVENTION

### Field of the Invention

The invention relates to a cover for a handrail of a public transportation vehicle. The invention also relates to a vehicle having the cover.

When a door of a bus or a public transportation rail vehicle fails, the driver can deactivate the door and block it mechanically. The defect in the door is generally communicated by using a door fault sign or a notice which is attached to the door by the driver. However, information is not provided for visually impaired passengers.

U.S. Pat. No. 6,854,163 B1 has also disclosed a cover for a handrail of a public transportation vehicle. The cover is constructed to be releasably connected to the handrail and includes characters in blind script for conveying information to visually impaired passengers.

German Utility model DE 299 20 776 U1, corresponding to U.S. Pat. No. 6,536,301, discloses a grip for passenger compartments of vehicles.

### SUMMARY OF THE INVENTION

It is accordingly an object of the invention to provide a haptic handrail cover and a vehicle having the cover, which overcome the hereinafore-mentioned disadvantages of the heretofore-known covers and vehicles of this general type and which improve comfort for visually impaired passengers.

With the foregoing and other objects in view there is provided, in accordance with the invention, a cover for a handrail of a public transportation vehicle, for example a bus or a tram, which is constructed to be releasably connected to the handrail, and includes characters in blind script for conveying information to visually impaired passengers.

The characters in blind script indicate, in particular, a defect in a door and/or the way to an adjacent door.

The term blind script is used to indicate a script which can be read by blind people. The reading is carried out in this context with the sense of touch of a finger. The script is raised with respect to the underlying surface or is embodied as an inscription or engraving. What is referred to as Braille is widespread. However, other types of blind script are also known.

According to the invention, the cover includes two half shells which have a latching mechanism with complementary parts, in order to lock the half shells to one another in a releasable fashion with regard to a handrail which is at least partially enclosed.

The cover is divided in two in the longitudinal direction. The half shells can be placed about a predefined section of the handrail and attached thereto by using the latching mechanism, by virtue of the fact that the cover encloses the predefined section of the handrail.

One half shell alone therefore surrounds only part of the predefined section of the handrail. One of the half shells is placed around the predefined section of the handrail and attached to the handrail by latching-in the other half shell. In this context, the handrail is then enclosed radially by the closed cover. The predefined section of the handrail is, in particular, enclosed completely. In particular, the predefined section of the handrail is clamped between the half shells.

Multiple guides are conceivable in order for the cover to be connected in a positionally fixed fashion to the handrail and therefore to be secured to the handrail in such a way that it doesn't shift along the handrail. For example, on one hand, the cover could apply a large clamping force to the handrail and have a coefficient of friction with respect to the handrail. For this purpose, the surface of the cover which faces the handrail is configured in a correspondingly suitable fashion. Moreover, the materials of the handrail and of the cover are matched to one another. Additionally or alternatively, the surfaces of the cover and of the handrail which are in contact with one another are matched to one another and selected in such a way that given a predefined clamping force a predefined and minimum force counteracts shifting of the cover along the handrail. The cover is therefore to be connected in a positionally fixed and releasable fashion to a handrail which extends, in particular, in the form of a tube and in a linear fashion.

On the other hand, the handrail has a predefined curvature in the predefined section of the handrail, and the cover is embodied in a complementary fashion with respect to the handrail. The cover encloses the handrail in the region of the curvature and is secured geometrically against shifting. In particular, if the area directly adjacent the predefined section of the handrail has a different curvature or no curvature. The cover can also be disposed in a positionally fixed fashion on a predefined section of the handrail, which is embodied in a linear fashion and has a curvature on one side or on both sides in the directly adjacent area. The cover is in turn embodied in a complementary fashion with respect to the predefined section of the handrail, that is to say linearly. The curvature of the handrail in the direct vicinity of the predefined section of the handrail prevents the cover from shifting in the direction or over the curvature.

A further development of the invention provides that the cover is constructed to cover a stop-request button or a door-opening button. The stop-request buttons or door-opening buttons are usually disposed on handrails and therefore are part of the handrail.

In order to cover the stop-request button or door-opening button, a cover which is embodied otherwise in the form of a tube can have a depression in order to cover the stop-request button or door-opening button and, if appropriate, also enclose it at the same time. If a stop-request button or door-opening button which is powered with respect to the handrail is at least partially enclosed, the cover can also be secured against shifting.

A further possible way of covering the stop-request button or door-opening button is to provide the cover with a protruding clip or rim which, in the mounted state of use of the cover, projects beyond the stop-request button or door-opening button and therefore covers it.

The cover is developed so as to be manufactured by using an additive application method. The application of the blind script can therefore be integrated in the fabrication process.

The information in blind script can also be in black script on the cover. In a further development, the cover has characters in luminance script, which is, in particular, fluorescent or phosphorescent so that it is visible to sighted passengers even in the dark.

With the objects of the invention in view, there is also provided a public transportation vehicle including at least one cover according to the invention.

In the state of use, the cover is releasably connected to a handrail of the vehicle and is developed so as to be disposed on the handrail in such a way that it covers a stop-request button or a door-opening button.

As already stated above, the cover can enclose a predefined section of the handrail.

For this purpose, the cover is developed so as to be complementary to a predefined section of the handrail. Of course, the cover is constructed so as to be complementary to a predefined section of the handrail which it encloses.

Then, in particular, the cover is adapted to the outer contour of the handrail, for example the inner diameter of the at least partially tubular cover is adapted to the outer diameter of the tubular handrail and also serves to follow the course of the handrail in the longitudinal direction.

With the objects of the invention in view, there is concomitantly provided a method for mounting a cover according to the invention. The method comprises applying a first half shell to a predefined section of a handrail by surrounding part of the predefined section of the handrail, applying a second half shell to the first half shell by surrounding part of the predefined section of the handrail and engaging a latching mechanism of the first and second half shells. Alternatively, the latching mechanism can also be embodied in such a way that the second half shell can be shifted along the first half shell in order to lock the half shells to one another.

The cover can be mounted and also removed quickly and easily without tools. The cover is to be embodied according to requirements. If, for example, a defective door is to be indicated, the cover is applied by the driver in the region of the defective door. If a visually impaired passenger then holds on to the handrail in the region of the door when getting out, the passenger learns that the door is defective. An additional script in black also informs the other passengers. An additional application of a sign or the like is also dispensed with.

Other features which are considered as characteristic for the invention are set forth in the appended claims.

Although the invention is illustrated and described herein as embodied in a haptic handrail cover and a vehicle having the cover, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings. The invention includes numerous embodiments, which are explained in more detail with reference to the following figures, in each of which an example of a configuration is illustrated.

### BRIEF DESCRIPTION OF THE SEVERAL VIEWS OF THE DRAWING

FIG. 1 is a diagrammatic, perspective view of a cover according to the invention;

FIG. 2 is a perspective view of a further example of a configuration of a cover according to the invention with a recess for covering a stop-request button or a door-opening button;

FIG. 3 is another perspective view of the cover according to FIG. 2; and

FIG. 4 is a longitudinal-sectional view of the cover according to FIG. 2.

### DETAILED DESCRIPTION OF THE INVENTION

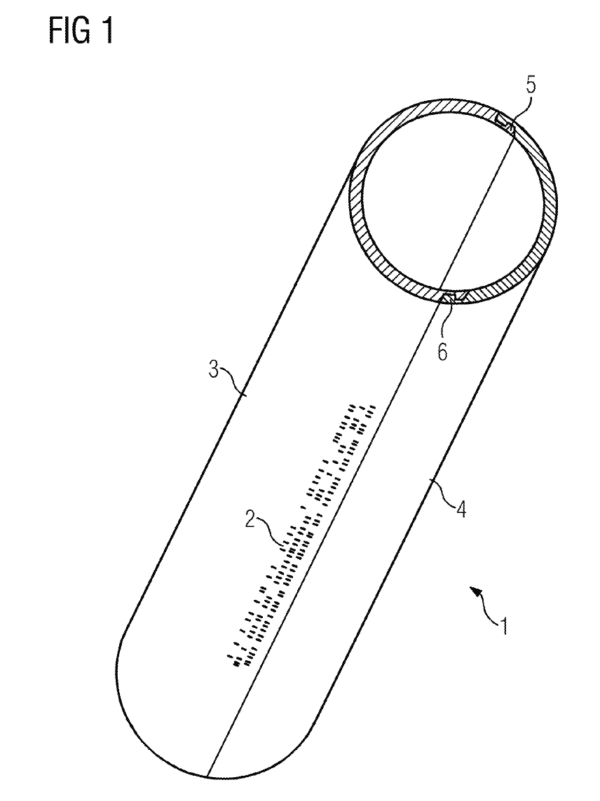

Referring now in detail to the figures of the drawings, in which the same elements are provided with the same reference symbols, and first, particularly, to FIG. 1 thereof, there is seen a perspective view of a cover 1 according to the invention. The cover 1 in this case includes two half shells 3, 4. The half shells can be placed about a predefined section of the handrail.

Furthermore, the half shells 3 and 4 of the cover 1 form a latching mechanism with complementary parts, in order to connect the half shells 3 and 4 to one another. The latching mechanism is formed in this case by a groove 5 and a tongue 6 which engage in one another and extend in the longitudinal direction. Each of the half shells 3 and 4 has in this case two grooves 5 and tongues 6 which are opposite one another and extend in opposite directions. The grooves 5 and tongues 6 of the half shells 3 and 4 are in turn embodied so as to be complementary to one another, with the result that a tongue 6 of the one half shell 3 engages in a groove 5 of the other half shell 4, and vice versa. Since the grooves 5 and tongues 6 are disposed on the respective edges of the half shells 3 and 4 and are oriented in opposing ways, the half shells 3 and 4 bear on one other and latch in and are therefore locked to one another by using a force which is directed toward one another. In this case, in addition, a half shell 3 having a groove 5 and a tongue 6 which are engaged, can be shifted with respect to the other half shell 4, along the half shell 4.

In the state of use, the half shells 3 and 4 each surround part of the handrail and enclose them together radially. In this case, a cover is outlined which extends in a linear fashion for a section of a handrail which extends in a tubular and also linear fashion. The cover is clamped between the half shells in order to avoid being shifted along the handrail.

The cover has characters in blind script for conveying information to visually impaired passengers. In this case, Braille 2 is provided on the half shell 3 and indicates a defective door to the passengers.

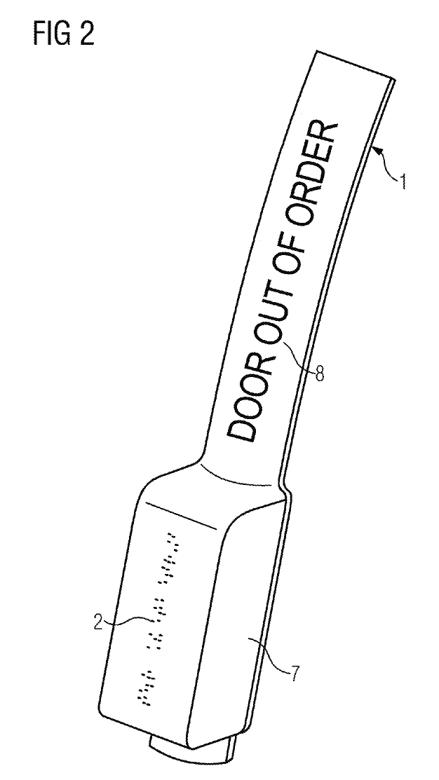

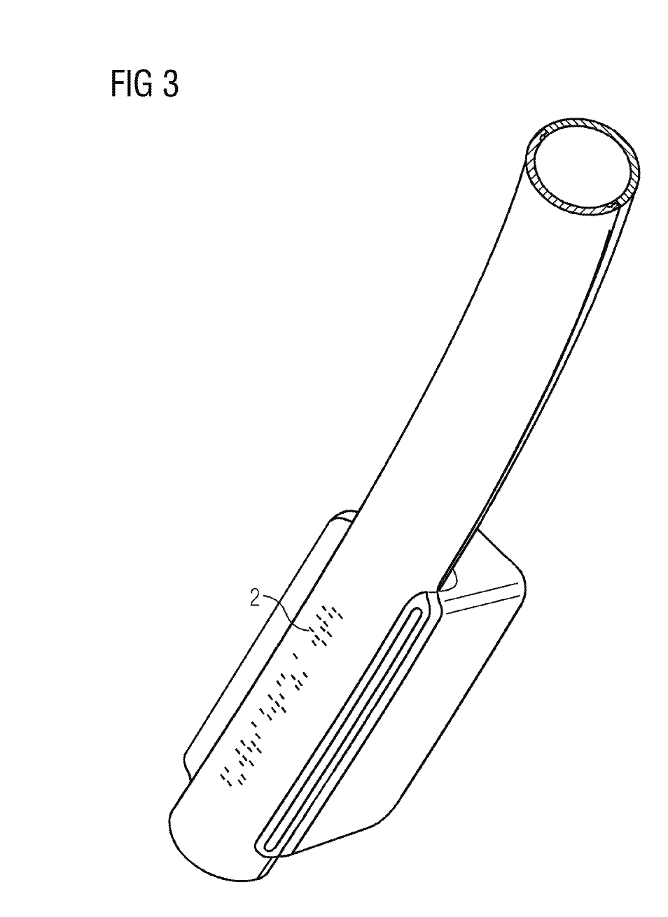

The cover 1 in FIG. 2 has, in addition to the Braille 2, black script 8 which also indicates the defective door. That script can also be embodied in luminescence script and/or in a fluorescent or phosphorescent fashion. As is apparent from FIG. 3, lettering in blind script can also be provided on the side of the cover 1 which is on the rear in the state of use.

The cover 1 is slightly curved in order to enclose a section of the handrail which is curved in a complementary fashion. Furthermore, the cover 1 is constructed in this case to cover a stop-request button or door-opening button. For this purpose, it has a recess 7. The curvature is independent of the recess 7. If the handrail does not run on in a continuous fashion in the direct surroundings of the predefined section, the cover 1 is therefore secured against slipping. In this case, the provided shape of the stop-request button or door-opening button is additionally used for positioning and securing.

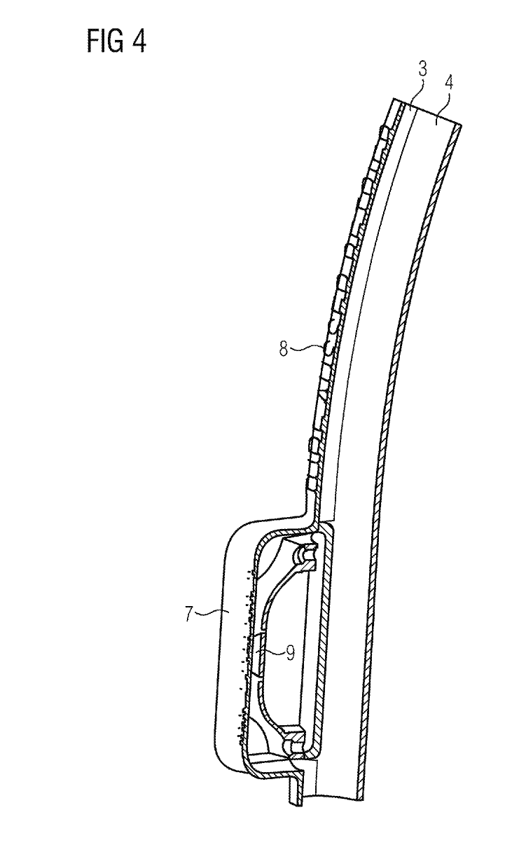

FIG. 4 illustrates the cover 1 in the mounted state of use. The stop-request button or door-opening button 9 is enclosed by the recess 7 of the cover in this case.

1. A cover to be releasably connected to a handrail of a public transportation vehicle, the cover comprising:
two half shells having complementary latching mechanisms configured to releasably lock said half shells to one another while enclosing the handrail; and
characters in blind script disposed on at least one of said half shells for conveying information to visually impaired passengers.

2. The cover according to claim 1, wherein said half shells are constructed to clamp a predefined section of the handrail.

3. The cover according to claim 1, wherein the cover is constructed to cover a stop-request button or door-opening button.

4. The cover according to claim 1, wherein the cover has characteristics of being manufactured by an additive fabrication method.

5. The cover according to claim 1, wherein said characters in blind script indicate at least one of a defect in a door or a way to an adjacent door.

6. A public transportation vehicle, comprising:
a handrail; and
at least one cover according to claim 1 being releasably connected to said handrail.

7. The vehicle according to claim 6, wherein said at least one cover is disposed on said handrail and covers a stop-request button or door-opening button.

8. The vehicle according to claim 6, wherein said at least one cover is constructed to be complementary to a predefined section of said handrail.
